(19) United States
(12) Patent Application Publication
(10) Pub. No.: US 2026/0225339 A1
(43) Pub. Date: Aug. 6, 2026

(54) DEVICE FOR FOLDING A PACKAGING STRIP OF A BATCH OF CONTAINERS

(71) Applicant: SIDEL PARTICIPATIONS, Octeville-sur-Mer (FR)

(72) Inventors: Matthieu OLIVIER, OCTEVILLE-SUR-MER (FR); Daniel DIESNIS, OCTEVILLE-SUR-MER (FR); Jonathan HAMEL, OCTEVILLE-SUR-MER (FR); Quentin LANGLOIS, OCTEVILLE-SUR-MER (FR)

(21) Appl. No.: 19/141,846

(22) PCT Filed: Dec. 21, 2023
(86) PCT No.: PCT/EP2023/087515

§ 371 Date: Jun. 20, 2025

(30) Foreign Application Priority Data
Dec. 22, 2022 (FR) FR2214305

(51) Int. Cl. B31D 1/00; B31D 1/06; B31F 1/00

(52) U.S. Cl. CPC B31D 1/0056; B31D 1/06; B31F 1/0019

(57) ABSTRACT

Provided is a device for folding a strip-made of material based on plant fibers for packaging a batch of containers. The strip includes means for folding at least one longitudinal edge of the strip, an unwinding surface. on which the lower face of the strip unwinds, at least one shoe on one side for folding the corresponding longitudinal edge. The shoe includes a profiled element partially overlapping the unwinding surface that is and inclined convergently in the longitudinal direction of unwinding, so that the corresponding longitudinal edge of said strip can be folded overlapping its upper face. The device includes a freely rotatable press roller mounted in alignment with the at least one shoe, the press roller bearing against said unwinding surface at the top.

### TECHNICAL FIELD OF THE INVENTION

The present invention relates to the field of packaging containers in batches.

In the context of the present invention, a container is of the bottle or vial type. Such a container is intended to contain, purely by way of example, a fluid, a liquid, powders or granules, in particular of the food or cosmetic type.

As is known, on an industrial production line, containers undergo several different successive treatments, such as the manufacture of the container, for example by plastic injection molding or stretch-blow molding in the case of a plastic bottle, followed by filling then closing with a cap and labeling. At the end of these treatments, the containers are said to be “finished”.

For handling purposes, such finished containers are packaged in batches. Thus, each batch comprises several containers grouped together, for example in a matrix arrangement, generally with an overall parallelepiped shape, often square or rectangular, in columns and rows. By way of illustration, a typical batch comprises six containers in two rows and three columns, also referred to as a “pack”.

During packaging, once the groups of containers have been produced, each group is wrapped, in particular covered with a film, in order to keep the containers together and to facilitate the handling of such a batch thus obtained.

This wrapping may be performed by way of a step of film wrapping or preferably shrink wrapping. To be specific, shrink wrapping a group of containers consists in wrapping it with a sheet of heat-shrinkable plastic film. A wrapped group then undergoes a step of heating so that the sheet hugs the overall external shape of the containers. In short, the sheet of film shrinks when subjected to heat to form a restraint ensuring the grouped containers are held together.

The grouping of containers, wrapping and heating are carried out using a dedicated facility such as a shrink-wrapper, through several successive stations. Such a heating operation represents a significant outlay in terms of energy, resulting in a high energy cost, while also being harmful to the environment. To be specific, the wrapping is carried out using a plastic film, obtained essentially from the petrochemical industry, which is single-use and not recycled to a sufficient extent.

Thus, there is a growing need to find an alternative to the use of this plastic, which generates a lot of waste and is expensive in terms of energy, both by simplifying the packaging and by reducing the total amount of material used.

### PRIOR ART

In this context, a known alternative to using shrink-wrap plastic film to form a batch is to hold the products together using strapping or banding, encircling the containers around the perimeter of the batch. Usually, this strapping can be carried out using a strip of braided plastic, or using adhesive or self-adhesive tape, encircling the perimeter of the batch, in contact with, or even adhesively bonded to, the corresponding walls of the containers to be held together. Such a strip is often made of a plastic or composite material, with an adhesive agent added. Although it makes it possible to limit the quantity of material used, this strip is still difficult to recycle, given the complexity of separating materials known as recyclable from other materials. Furthermore, this strip has the disadvantage that, when removed, it can cause damage to the containers, with the risk of damaging the label.

Moreover, a handle may be added to the top of a batch to facilitate transport and handling. Such a handle takes the form of an adhesive strip, sometimes reinforced in the middle with a layer of cardboard, paper or foam. This strip is attached to a batch, by fastening vertically along the side walls of two opposite containers. It is fastened using an adhesive, at a height sufficient to offer resistance to tearing when the batch is lifted, depending on the weight of the batch.

This handle must also resist bending and twisting in its middle part where it is gripped. To be specific, such a handle is made from plastic or composite materials, with elastic properties limiting tearing.

Again, the use of plastic is problematic, especially when combined with other substances, such as glues or adhesives, compromising the possibilities of recycling the packaging. In particular, the fact that different materials are attached by gluing, namely materials constituting the strip and the handle, which are recycled through different streams, makes recycling considerably more difficult.

In the same vein, the affixing of a strapping or banding strip to a batch is carried out using a machine referred to as a “stretch wrapper”, while the affixing of a handle to a batch is carried out using a machine referred to as a “handle applicator”.

It is thus necessary to develop an alternative to plastic for packaging products in batches, which is environmentally friendly and ensures the batch is held together optimally, whether during transport or during storage, as well as during handling, especially by a consumer.

Such a packaging means must have high resistance to tearing, in order to guarantee the integrity of the batch formed by the group of containers. It must not only be reliable and solid, but also eco-friendly, in terms of both composition and the quantity of waste generated, which must be easy to recycle in order to reduce the environmental impact.

One alternative solution is to use a strapping or banding strip, and possibly a handle, made from a material based on plant cellulose fibers, such as paper or cardboard, without plastic or materials obtained from the petrochemical industry.

However, such paper material offers little resistance to tearing, especially transversely, although plant fibers can provide high longitudinal tensile strength.

### SUMMARY OF THE INVENTION

The present invention relates specifically to the folding of a strip of material based on plant fibers, such as paper, with a view to being affixed as strapping or banding, but also as a handle, on a batch of containers to be held together for transport and handling purposes. By shaping such a paper material by folding it to have extra thickness, locally along at least one longitudinal edge of said strip, the invention makes it possible to considerably increase its strength, in particular greater lateral strength, limiting the risk of tearing along the fold line thus formed.

The invention therefore relates to a device for folding a strip of material based on plant fibers, such as paper, with a lower face and an upper face, said strip being intended for packaging a batch of containers.

Such a folding device is capable of folding one and/or the other of the longitudinal edges of the strip, while ensuring that the folded edge(s) are held in place.

To this end, the folding device comprises
an inlet and an outlet, and a path along which said strip unwinds, extending from the inlet to said outlet in a longitudinal direction of unwinding from upstream to downstream, and along said path,
means for folding at least one longitudinal edge of said strip,
at least one deflection roller upstream of said folding means.

Advantageously, the folding device is characterized in that said folding means comprise
an unwinding surface on which the lower face of said strip unwinds,
at least on one side of said unwinding surface, at least one shoe for folding the corresponding longitudinal edge of said strip unwound on said surface, in that
said shoe comprises a profiled element partially overlapping said surface and inclined convergently in said longitudinal direction of unwinding, in such a way as to fold said corresponding longitudinal edge of said strip overlapping its upper face, forming a fold line, and in that said folding device comprises
downstream of said folding means and along said path, at least one press roller, mounted in alignment with said at least one shoe and freely rotatable, bearing against said unwinding surface at the top.

According to additional, non-limiting, features, the folding means of such a device comprise
on the opposite side of said unwinding surface, an additional shoe
said at least one press roller also being mounted in alignment with said additional shoe.

According to one embodiment, at least said shoe is removable.

According to one embodiment, said shoe and said additional shoe are provided to be adjustable in terms of moving toward and away from one another.

According to one embodiment, said press roller comprises means for adjusting the pressure applied against said unwinding surface.

According to one embodiment, said press roller comprises heating means.

According to one embodiment, said folding device at the inlet, upstream of said folding means, positioned higher than said path, means for depositing an adhesive in contact at least with the upper face of said strip.

According to one embodiment, said at least one deflection roller is positioned at a longitudinal distance from the upstream face of said folding means and in that said folding device comprises a plate mounted on the upper face at least of said shoe, said plate extending as far as at least one deflection roller.

In some embodiments, the folding device comprises means for tensioning the strip. The means for tensioning the strip may be located upstream and/or downstream of the folding shoe. The tensioning means make it possible to maintain the tension or to adjust it, depending on the type of material from which the strip 1 is made, the type of packaging to be produced, and also the type of batch of containers.

The invention also relates to a machine for affixing a strip to a batch of containers, by stretch wrapping, strapping or banding a batch, or by covering, or a machine of handle applicator type, said machine being equipped with said folding device.

To this end, said machine comprises
an unwinder for unwinding a reel of said material of said strip,
downstream of said unwinder, a module for depositing said strip in contact with said batch,
means for cutting said strip to a given length, characterized in that it comprises
between the unwinder and the depositing module, a folding device as described above.

The invention also relates to a corresponding folding method.

According to one embodiment, said method for folding a strip for packaging a batch of containers, said strip being made of a material based on plant fibers, such as paper, with a lower face and an upper face,
comprises at least the following steps
unwinding said strip from a reel of said material, along a path in a longitudinal direction from upstream to downstream,
keeping said strip under tension as it is unwound along said path,
folding at least one longitudinal edge of said strip overlapping said upper face, forming a fold line, by passing along at least one shoe overlapping said path with an inclined profile converging in said longitudinal direction and oriented toward the inside of said path,
downstream, applying pressure by bearing against said fold line.

According to additional, non-limiting, features, the opposite longitudinal edge of said strip is folded, overlapping said upper face, forming an opposite fold line, by passing along at least one additional shoe with an inclined profile converging in said longitudinal direction and oriented toward the inside of said path, downstream, pressing is carried out by bearing against said opposite fold line.

According to one embodiment, at least said fold line is heated during said pressing.

Preferably, although this is not limiting, the folding method may consist in implementing the folding device according to the invention.

### PRESENTATION OF THE DRAWINGS

Other features and advantages of the invention will become clear from the following detailed description of the non-limiting embodiments of the invention, with reference to the appended figures, in which:

FIG. 1 schematically depicts a perspective view of an embodiment of the vacuum folding device;

FIG. 2 schematically depicts a simplified side view of a folding device, during the unwinding of a strip, showing in particular the path taken by the strip as it is folded, then the accentuation of the fold formed, by a press roller;

FIG. 3 schematically depicts a simplified view of a reel with one of its two longitudinal edges being folded at a shoe;

FIG. 4 schematically depicts a simplified view of a reel with its two longitudinal edges being folded by a shoe and an additional shoe;

FIG. 5 schematically depicts a three-quarter perspective view from above of an embodiment of a pair of shoes, showing in particular the beveled inclined inner face, converging from upstream to downstream curvature;

FIG. 6 schematically depicts a three-quarter perspective view from below of the pair of shoes of FIG. 5, showing in particular the offset converging from upstream to downstream.

### DETAILED DESCRIPTION

The present invention relates to the packaging of containers grouped together in batches or “packs”, by means of a packaging strip 1, hereinafter referred to as a “strip”.

The packaging of a batch of containers may be carried out by banding or strapping said strip 1 around a group of containers, or by covering said batch, or by affixing a handle made from said strip 1.

In the context of the present invention, said strip 1 is made of a material based on plant fibers, such as paper, or cardboard.

Such a strip 1 is made from a material which generally has an elongate, rectangular parallelepiped shape, of small thickness. Said material is stored in the form of a reel 1000, by winding said material around a central mandrel.

Said strip 1 (and the material from which it is made) therefore comprises a lower face 100 and an upper face 101. Said strip 1 also comprises two longitudinal edges, namely a longitudinal edge 102 and an opposite longitudinal edge 103.

According to one embodiment, said material may have a coating, such as a layer of adhesive, in particular a layer of adhesive which can be activated, for example heat-activated. Such a coating may be applied to one or other of said faces 100, 101 of the material, preferably to the upper face 101.

In order to shape the material into the packaging strip 1, the invention relates to a device 2 for folding said strip 1 for packaging a batch of containers.

Such a folding device 1 comprises an inlet 20 and an outlet 21, and a path 22 along which said strip 1 unwinds. Said path 22 extends from the inlet 20 to said outlet 21 in a longitudinal direction of unwinding from upstream to downstream. The inlet 20 is therefore supplied with material, in particular from a station for unwinding a reel 1000. The material then follows the path 22, through the folding device 1, so that the material is shaped into said strip 1 at the outlet 21 Such a path is notably depicted in dotted lines in FIG. 2, with an arrow showing the longitudinal direction of unwinding.

Furthermore, along said path 22, the folding device 1 comprises means 3 for folding at least one longitudinal edge 102 of said strip 1. Preferably, the folding means 3 make it possible to fold said longitudinal edge 102 as well as the opposite longitudinal edge 103.

The folding device 1 advantageously comprises, in some embodiments, means for tensioning the strip. The strip tensioning means may be located upstream and/or downstream of the folding shoe. The tensioning means make it possible to maintain or adjust the tension, depending on the type of material from which the strip 1 is made, the type of packaging to be produced, and also the type of batch of containers.

The means for tensioning the strip 1 also make it possible to maintain the tension of the strip 1 while, as it unwinds from the inlet to the outlet, or within an affixing machine or packaging station, it undergoes speed variations along its path. The tensioning means therefore make it possible to absorb these speed variations.

The folding device 1 also comprises at least one deflection roller 4 upstream of said folding means 3. Preferably, said folding device 1 may comprise several deflection rollers 4, located before the folding means 3. In particular, a tensioning roller 40 makes it possible to adjust the tension of the material unwound from the inlet 20 to the folding means 3. Such a tensioning roller 40 may also help to keep the material aligned, in particular by means of lateral stops. In some embodiments, the tensioning means are formed by said tensioning roller 40. This feature is very advantageous because it makes it possible to maintain the right tension for the strip 1 forming a packaging means, such as a handle or strap in particular. Furthermore, in a packaging line, because a strip 1 comprising at least one fold must be supplied continuously, it can be difficult to maintain said strip 1 under sufficient tension for its use in the machine for affixing said strip 1 to a batch of containers, in other words in a container packaging station. Furthermore, depending on the use of the strip 1, or depending on the batch of containers to be packaged, the tension required for the strip 1 may need to be adjusted. It is therefore useful to be able to adjust said tension using the tensioning means.

According to one embodiment, said at least one deflection roller 4 has a striated peripheral face, in order to limit the surface area for contact with the material, in particular in the case of a material with a coating, in particular adhesive. In short, the deflection roller 4 has a grooved surface, in order to limit the surface area for adhesion with the upper face 101 of the strip 1, especially with the coating if present and/or any adhesive previously deposited.

Advantageously, in order to improve the strength of the material, in particular to increase the resistance to transverse tearing, the invention provides for shaping said material by folding at least one longitudinal edge 102 and thus obtaining a strip 1 with said at least one folded longitudinal edge 102.

To this end, said folding means comprise a unwinding surface 5 on which the lower face 100 of said strip 1 unwinds. Such an unwinding surface 5 may be provided to be flat, horizontal or essentially horizontal, along which the strip 1 is unwound flat, its lower face 100 sliding in contact with said unwinding surface 5. The flatness of the surface 5 makes it possible to ensure the flatness of the strip 1, which is advantageous for its use as a means for packaging a batch of containers. Furthermore, the flatness of the surface 5 makes it possible to produce the at least one fold of the strip 1 continuously, at a satisfactory rate, while maintaining the integrity of said strip 1.

According to one embodiment, said unwinding surface 5 may be provided to be movable, by means of a conveyor or rollers, which are provided to be freely rotatable, or even motorized.

Moreover, at least on one side of said unwinding surface 5, the folding means 3 comprise at least one shoe 30 for folding said at least one longitudinal edge 102, namely the corresponding edge 102, 103 of said strip 1 unwound on said surface 5 (i.e. the right-hand edge or the left-hand edge depending on where said shoe 30 is positioned).

According to a preferred embodiment, in order to fold the opposite edge 103, the folding means 3 comprise an additional shoe 31, located on the opposite side of said unwinding surface 5.

Such an additional shoe 31 may be located opposite said shoe 30, transversely aligned on the other side of said surface 5, namely symmetrically with respect to said direction of unwinding.

According to another embodiment, said additional shoe 31 may be positioned upstream or downstream relative to said shoe 30.

According to a corresponding embodiment, opposite the shoe 30 and/or the additional shoe 31, a protruding wall provides a stop against which the corresponding longitudinal edge 102, 103 may be held slidingly. In other words, said wall makes it possible to maintain the trajectory of the strip 1 as it is unwound, without folding its corresponding longitudinal edge 102, 103, while the edge located on the other side is folded as it passes within said shoe 30 and/or said additional shoe 31.

According to one embodiment, the shoe 30 and the additional shoe 31 are similar, that is they have the same shape, symmetrically with respect to the direction of unwinding.

According to another embodiment, said shoe 30 and said additional shoe 31 have different shapes, making it possible to fold the longitudinal edge 102 and the opposite longitudinal edge 103 differently (i.e. along different fold lines 200 and overlapping the strip 1 over different widths).

In this regard, said shoe 30 comprises a profiled element 300 partially overlapping said surface 5. In other words, said shoe 30 has a shape with a portion which extends above said surface 5. The shoe 30 is therefore positioned on the side of the path and extends laterally over said surface 5.

Such an overlap of the shoe 30 makes it possible to keep the strip 1 between the part overhanging the path 22 and the unwinding surface 5, ensuring that said strip 1 is pressed against said surface 5, and thus that it is held in place at the time of folding as it unwinds from the upstream part to the downstream part of said shoe 30. Furthermore, said shoe 30 comprises a profiled element 300 inclined convergently in said longitudinal direction of unwinding, in such a way as to fold said corresponding longitudinal edge 102, 103 of said strip 1, overlapping its upper face 101, forming a fold line 200. In other words, the profiled element 300 has a slope and/or a face with an angle decreasing from upstream to downstream.

In short, the convergent shape of the profiled element 300 reduces the width of the passage of the path 22 on the strip 1 unwinding surface 5, which then becomes less wide than the material, forcing the folding of a longitudinal edge 102, 103, overlapping its upper face 101. In addition, this convergent shape, decreasing along the length of the shoe 30, assists the folding of said edge 102, 103, gradually pushing it against the upper face 101. Thus, the profiled element 300 and its specific inverted bevel shape bends the longitudinal edge 102, 103 and folds it against the upper face 101 of the strip 1.

According to one embodiment, as can be seen in FIGS. 5 and 6, said profiled element 300 has an offset 301 extending vertically or substantially vertically, serving as a lateral stop for the longitudinal edge 102, 103 of the strip 1. Such an offset 301 rises to a minimal height, from 0.1 to 2 millimeters (mm). The overlapping convergent portion extends above said offset 301. The overlapping part of the path 22 extends above said offset 301. The profiled element 300 comprises a wall 302 having the convergent inclined feature. As can be seen, said wall 302 extends obliquely, decreasing from the upper wall 303, toward the bottom of said shoe 30, until it reaches the downstream end of said offset 301.

Furthermore, the shoe 30 may comprise a recess 304, downstream of said offset 301. The downstream part of the shoe 30 then has a smaller width than the upstream part, freeing up a space after the overlapping portion of said shoe 30.

Said shoe 30 also has an inclined front wall 305, increasing from upstream to downstream.

According to one embodiment, said shoe 30 has a length of approximately 40 mm, with a convergent inclined portion of approximately 30 mm.

Thus, with a shoe 30 (and/or an additional shoe 31) shaped as such, the edge 102 (and/or the opposite edge 103) may be folded as it unwinds, while it is passing through the folding means 3, without the risk of tearing said edge 102.

Furthermore, when put in place, the strip 1 is threaded through the folding means 3, the edge(s) 102, 103 bending as it is inserted between the shoe(s) 30, 31.

According to one embodiment, said shoe 30 is removable. In the corresponding embodiment, the two shoes 30, 31 are removable. Thus, one and/or the other may be replaced by other shoes 30, 31 with different profiled elements 300, to adapt to the fold(s) to be made, or even replaced if they are worn.

According to one embodiment, said shoe 30 and said additional shoe 31 are provided to be adjustable in terms of moving toward and away from one another. This lateral adjustment of the center distance makes it possible to change the folding carried out, in particular the width of the edge(s) 102, 103 overlapping the upper face 101 of the strip 1.

According to one embodiment, said at least one deflection roller 4 is positioned at a longitudinal distance from the upstream face of said folding means 3. This longitudinal distance is designed to be adjustable, in order to adapt to the material of the strip 1 to be shaped, as well as the width of the fold of the edge(s) 102, 103 to be made. To be specific, this distance must be adjusted with extreme precision, in order to allow the folding of the strip 1 as it unwinds.

In addition, said folding device 2 comprises a plate 7 mounted on the upper face at least of said shoe 30 (and/or of said additional shoe 31), said plate 7 extending as far as at least one deflection roller 4. Such a plate 7 prevents the strip 1 from rising above said deflection roller 4 and forming a bulge or a crease transversely, in particular when the upper face 101 is covered with a coating, in particular adhesive. Said plate 7 therefore closes the distance separating the upstream part of the folding means 3 and said deflection roller 4.

According to one embodiment, upstream of the folding means 3, the folding device 2 may comprise pre-folding means. These pre-folding means make it possible to partially fold the edge(s) 102, 103, by bending them upwards, or even to carry out an initial accentuation of the fold line(s) 200.

These pre-folding means may be of any type. According to one embodiment, the pre-folding means may comprise at least one bearing or surface, with a flat, curved, chamfered or beveled peripheral face. Said bearing or said surface may be inclined relative to the plane of the path 22 of said strip 1, forcing during its unwinding the curvature thus applied to said edge 102, 103.

Furthermore, in order to ensure that the edge(s) 102, 103 are folded correctly during insertion but also as the strip 1 unwinds, said folding device 2 advantageously comprises, downstream of said folding means 3 and along said path 22, at least one press roller 6, mounted in alignment with said at least one shoe 30 and freely rotatable, bearing against said unwinding surface 5 at the top. In other words, said press roller 6 crushes and accentuates the fold at the outlet of the folding means 3, ensuring that the longitudinal edge 102, 103 remains folded.

According to a corresponding embodiment, in the case of an additional shoe 31, said at least one additional press roller 60 is also mounted in alignment with said additional shoe 31. Thus, it is possible to crush and accentuate each of the folds made along the two longitudinal edges 102,103. Furthermore, the press roller 6 and the additional press roller 60 may be mounted coaxially, aligned transversely, or offset from one another. The press roller 6 and the additional press roller 60 may also be a single roller.

Furthermore, the press roller 6 may apply pressure over the entire width of the surface 5, therefore of the strip 1, ensuring that its flatness is maintained downstream of the folding means 3, as well as at the outlet 21 of the folding device 2. The press roller 6 may also ensure sufficient tension from the upstream deflection roller 4, to allow the strip 1 to remain flat, in contact with the surface 5 as it passes through said folding means 3.

According to one embodiment, opposite said press roller 6, said strip 1 unwinding surface 5 may comprise a specific area. It may be provided for this specific area to be reinforced, with a dedicated shape, in particular concave and complementary to said press roller 6, or conversely convex, in particular domed. Said specific area may also comprise one or more counter-rollers, freely rotatable or motorized, forming a rolling jaw with said press roller.

Furthermore, said press roller 6 may have a generally cylindrical shape, with a flat peripheral surface.

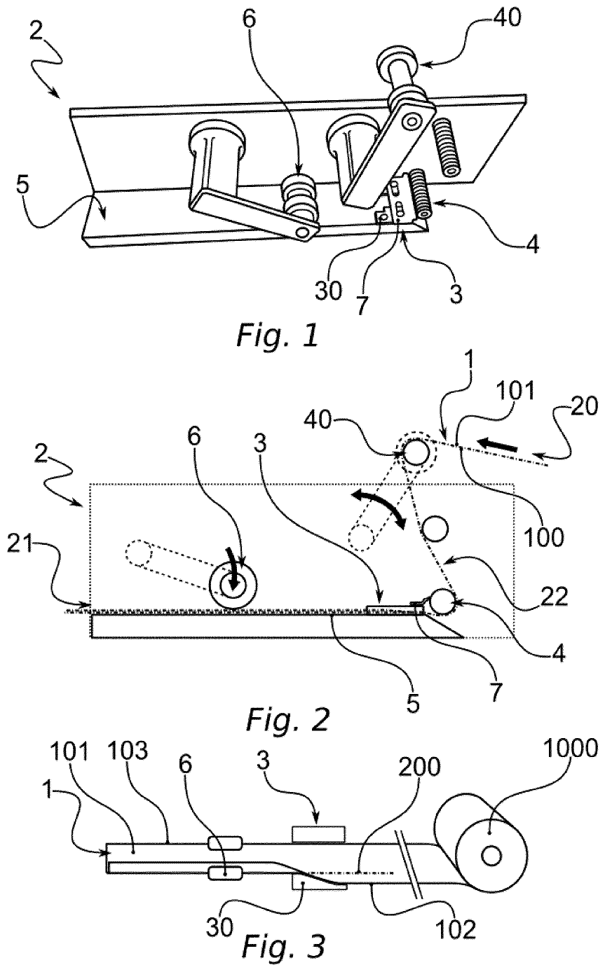

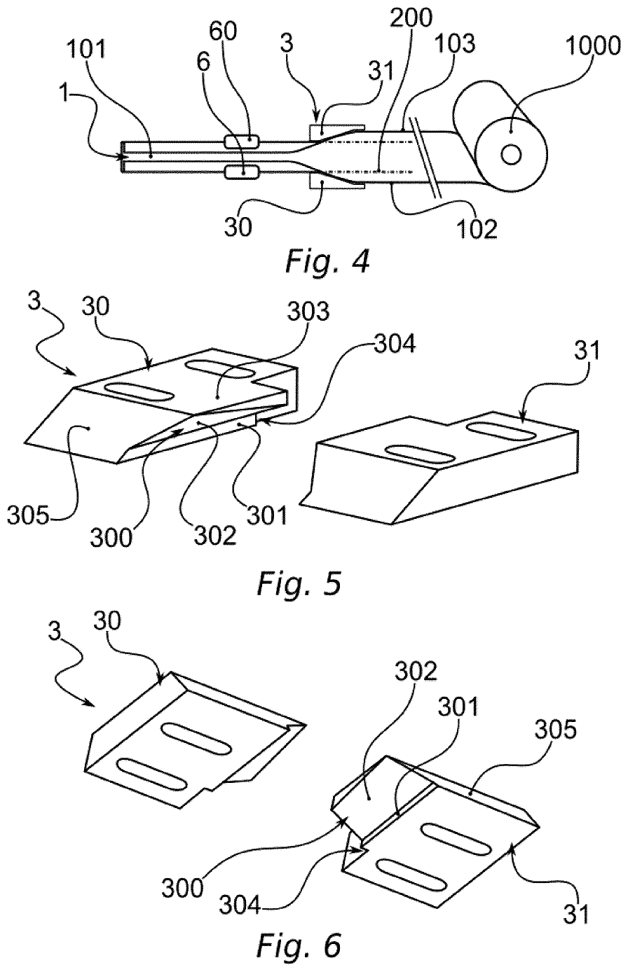

According to one embodiment, shown in particular in FIG. 1, said press roller 6 comprises one or more bearings, notably of ball bearing type. In particular, a ball bearing is placed facing each downstream end of each of the shoes 30, 31, facing the fold to be compressed.

According to one embodiment, said press roller 6 comprises means for adjusting the pressure applied against said unwinding surface 5. Thus, it is possible to adjust the pressure of the press roller 6, depending on the thickness of the material of the strip 1, and therefore the thickness of the folded edge(s) 102, 103.

According to one embodiment, said press roller 6 comprises heating means. Such heating methods make it possible to improve the accentuation of the fold made. In particular, these heating means make it possible to activate an adhesive coating intended to be heat-activatable, especially in the case of a coating applied to the upper face 101 of the strip 1. Said heating means also make it possible to accelerate the effect of the adhesive already applied to the strip 1.

According to another embodiment, said at least one deflection roller 4 may also comprise preheating means, allowing partial or full activation of a heat-activatable coating.

In this regard, note that an adhesive may be deposited on said upper face 101, upstream of the folding means 3.

To this end, according to one embodiment, said folding device 2 comprises at the inlet, upstream of said folding means 3, positioned higher than said path 22, means for depositing an adhesive in contact at least with the upper face 101 of said strip.

This adhesive may be applied to all or part of the upper face 101, preferably at the location provided for the fold line(s) 200. Thus, once folded, the longitudinal edge(s) 102, 103 come into contact with the adhesive, which is compressed by the press roller 6, ensuring that said edge(s) 102, 103 are held securely folded against the upper face 101 of the strip 1.

In addition, the adhesive may be of any type, whether heat-activatable or not.

Thus, the combination of the folding means 3, with the shoe(s) 30, 31, with the press roller 6, ensures that the fold(s) of the longitudinal edge(s) 102, 103 are formed and maintained, this being necessary for a paper-based material, in particular when the overlap width is minimal, of the order of one or a few millimeters.

The invention also relates to a machine for affixing a packaging strip 1 to a batch of containers, by stretch wrapping, strapping or banding said batch, or a machine of handle applicator type (a machine especially for affixing a handle to a batch of products).

Furthermore, said affixing machine comprises an unwinder for unwinding the reel 100 of said material of said strip 1. In addition, downstream of said unwinder, the machine comprises a module for depositing said strip 1 in contact with said batch.

The machine also comprises means for cutting said strip 1 to a given length, depending on the dimensions of the batch and the containers to be packaged, or depending on the length of the handle.

Advantageously, said affixing machine comprises, between the unwinder and the depositing module, a folding device 2 according to the invention.

In short, the invention provides for equipping a machine for stretch wrapping batches of containers, or a machine for affixing a handle, referred to as a handle applicator, with a folding device 2, located between the inlet and the outlet of said machine, to shape the material into the packaging strip 1 as it passes through said machine.

For example, in the case of a handle applicator or a stretch wrapping machine, the folding device 2 may be inserted between the reel 1000 and the tension module, referred to as a “dancer”, or between the dancer and the depositing module. In this case, the folding device 2 advantageously comprises tensioning means formed at least by a dancer-type tensioning module.

The invention also relates to a method for folding a strip 1 for packaging a batch of containers. Such a folding method may be specifically provided for the implementation of the folding device 2 according to the invention, as described above.

As stated above, said strip 1 is made of a material based on plant fibers, such as paper, or cardboard. The strip 1 therefore comprises a lower face 100 and an upper face 101.

Furthermore, said folding method comprises several non-limiting steps.

The method consists in unwinding said strip 1 from a reel 1000 of said material, along a path 22 in a longitudinal direction from upstream to downstream.

Moreover, as it is unwound along said path 22, said strip 1 is kept under tension, in particular by means of at least one deflection roller 4, or by means of tensioning means.

As it is unwound, at least one longitudinal edge 102 of said strip 1 is folded over, overlapping said upper face 101, forming a fold line 200, by passing along at least one shoe 30 overlapping said path 22 with an inclined profile converging in said longitudinal direction and oriented toward the inside of said path 22.

In addition, downstream of the folding, pressure is applied by bearing against said fold line 200, in particular by means of a press roller 6. This pressing by bearing allows the fold to be accentuated, improving the flatness as well as its durability over time. This pressing also makes it possible to fix the edge 102, 103 folded against the upper face 101 in the case where an adhesive is applied upstream on said upper face 101.

According to one embodiment, the method provides for folding the two longitudinal edges 102, 103. To this end, a step comprises folding the opposite longitudinal edge 103 of said strip 1 overlapping said upper face 101, forming an opposite fold line, by passing along at least one additional shoe 31 with an inclined profile converging in said longitudinal direction and oriented toward the inside of said path.

Such folding of the opposite edge 103 may be carried out opposite, symmetrically with respect to the folding of said edge 102, or offset upstream or downstream.

In addition, downstream, pressing is carried out by bearing against said opposite fold line.

In this regard, according to one embodiment, the folding method provides for heating at least said fold line 200 during said pressing, in particular by means of a press roller 6 provided to apply heat.

According to one embodiment, the folding method provides for preheating the strip 1 upstream of folding.

According to one embodiment, the folding method provides for pre-folding the longitudinal edge(s) 102, 103 with the folding, by bending them toward the upper face 101, but without folding them down.

1. A folding device for folding a strip for packaging a batch of containers, said strip being made of material based on plant fibers, the strip comprising a lower face and an upper face, said device comprising:
an inlet and an outlet, and a path along which said strip unwinds, extending from the inlet to said outlet in a longitudinal direction of unwinding from upstream to downstream, and along said path;
a folding means for folding at least one longitudinal edge of said strip;
at least one deflection roller upstream of said folding means, wherein said folding means comprises:
an unwinding surface on which the lower face of said strip unwinds; and
at least on one side of said unwinding surface, at least one shoe for folding the corresponding longitudinal edge of said strip unwound on said surface,
wherein
said shoe comprises a profiled element partially overlapping said surface and inclined convergently in said longitudinal direction of unwinding, in such a way as to fold a corresponding longitudinal edge of said strip overlapping the upper face, forming a fold line, and
wherein said folding device comprises
at least one press roller downstream of said folding means and along said path, the press roller mounted in alignment with said at least one shoe and freely rotatable, bearing against said unwinding surface at a top.

2. The folding device as claimed in claim 1, wherein said folding means comprise:
an additional shoe on the opposite side of said unwinding surface; and,
wherein said at least one press roller is mounted in alignment with said additional shoe.

3. The folding device as claimed in claim 1, wherein at least said shoe is removable.

4. The folding device as claimed in wherein
said shoe and said additional shoe are configured to be adjustable in terms of moving toward and away from one another.

5. The folding device as claimed in claim 1, wherein
said press roller comprises means for adjusting the pressure applied against said unwinding surface.

6. The folding device as claimed in claim 1, wherein said press roller comprises heating means.

7. The folding device as claimed in claim 1, the device comprising at the inlet,
upstream of said folding means, positioned higher than said path, means for depositing an adhesive in contact at least with the upper face of said strip.

8. The folding device as claimed in claim 1, wherein
said at least one deflection roller is positioned at a longitudinal distance from the upstream face of said folding means, and wherein the device comprises
a plate mounted on the upper face at least of said shoe, said plate extending as far as the at least one deflection roller.

9. A machine for affixing a packaging strip to a batch of containers, comprising:
an unwinder for unwinding a reel of said material of said strip; a module for depositing said strip in contact with said batch, wherein the module is downstream of said unwinder;
means for cutting said strip to a given length; and
a folding device between the unwinder and the depositing module, the folding device comprising:
an inlet and an outlet, and a path along which said strip unwinds, extending from the inlet to said outlet in a longitudinal direction of unwinding from upstream to downstream, and along said path;
means for folding at least one longitudinal edge of said strip;
at least one deflection roller upstream of said folding means, wherein said folding means comprises:
an unwinding surface on which the lower face of said strip unwinds; and
at least on one side of said unwinding surface, at least one shoe for folding the corresponding longitudinal edge of said strip unwound on said surface.
wherein said shoe comprises a profiled element partially overlapping said surface and inclined convergently in said longitudinal direction of unwinding, in such a way as to fold said corresponding longitudinal edge of said strip overlapping the upper face, forming a fold line, and
wherein said folding device comprises at least one press roller downstream of said folding means and along said path, the press roller mounted in alignment with said at least one shoe and freely rotatable, bearing against said unwinding surface at the top.

10. A method for folding a strip for packaging a batch of containers, said strip being made of a material based on plant fibers and comprising a lower face and an upper face, the method comprising at least the following steps:
unwinding said strip from a reel of said material, along a path in a longitudinal direction from upstream to downstream;
keeping said strip under tension as the strip is unwound along said path; and
folding at least one longitudinal edge of said strip overlapping said upper face, forming a fold line, by passing along at least one shoe overlapping said path with an inclined profile converging in said longitudinal direction and oriented toward the inside of said path,
downstream, applying pressure by bearing against said fold line.

11. The folding method as claimed in claim 10, wherein
an opposite longitudinal edge of said strip is folded, overlapping said upper face, forming an opposite fold line, by passing along at least one additional shoe with an inclined profile converging in said longitudinal direction and oriented toward the inside of said path,
downstream, pressing is carried out by bearing against said opposite fold line.

12. The folding method as claimed in claim 10, wherein at least said fold line is heated during said pressing.

13. The folding method as claimed in claim 11, wherein at least said fold line is heated during said pressing.
